(19) United States
(12) Patent Application Publication
(10) Pub. No.: US 2014/0361476 A1
(43) Pub. Date: Dec. 11, 2014

(54) SEPARATING APPARATUS

(71) Applicants: Hon Hai Precision Industry Co., Ltd., New Taipei (TW); Fu Tai Hua Industry (Shenzhen) Co., Ltd., Shenzhen (CN)

(72) Inventors: ZHI-GUO SUN, Shenzhen (CN); JUN-LIN PENG, Shenzhen (CN); YU-LUN LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/205,618

(22) Filed: Mar. 12, 2014

(30) Foreign Application Priority Data
Jun. 11, 2013 (CN) 2013102302247

(51) Int. Cl. B23Q 3/154

(52) U.S. Cl. CPC B23Q 3/1546
USPC 269/8

(57) ABSTRACT

A separating apparatus for separating stacked magnetically conductible workpieces, includes a support assembly and a magnet assembly positioned adjacent to the support assembly. The support assembly includes a support member and a support rod fixedly coupled with the support member, the support is used for supporting the tacked magnetically conductible workpieces. The magnet assembly includes a holding member and at least one magnet member received in the holding member. The inner magnetic field of the at least one magnet member has a direction parallel to an extending direction of the support member. The at least one holding member is spaced from the support rod by a predetermined distance thereby separating the stacked magnetically conductible workpieces apart along the support rod via the inner magnetic field of the at least one magnet member.

### FIELD

The present disclosure generally relates to separating apparatus, and particularly to a separating apparatus for separating stacked magnetically conductible workpieces independently.

### BACKGROUND

In a production line, magnetically conductible workpieces in a slice shape, such as iron sheets or other magnetically conductible sheets, may need to be cleaned. However, because some of the workpieces may be stacked together in a solution, shielded surfaces of the stacked magnetically conductible workpieces cannot be cleaned. An operator will take time to manually separate the stacked magnetically conductible workpieces apart, which results in a low cleaning efficiency.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled view of a first embodiment of a separating apparatus.

FIG. 2 is an exploded view of the separating apparatus of FIG. 1.

FIG. 3 is a working state of the separating apparatus of FIG. 1 with a plurality of stacked magnetically conductibility workpieces.

FIG. 4 is an exploded view of a second embodiment of a separating apparatus.

FIG. 5 is an exploded view of a third embodiment of a separating apparatus.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

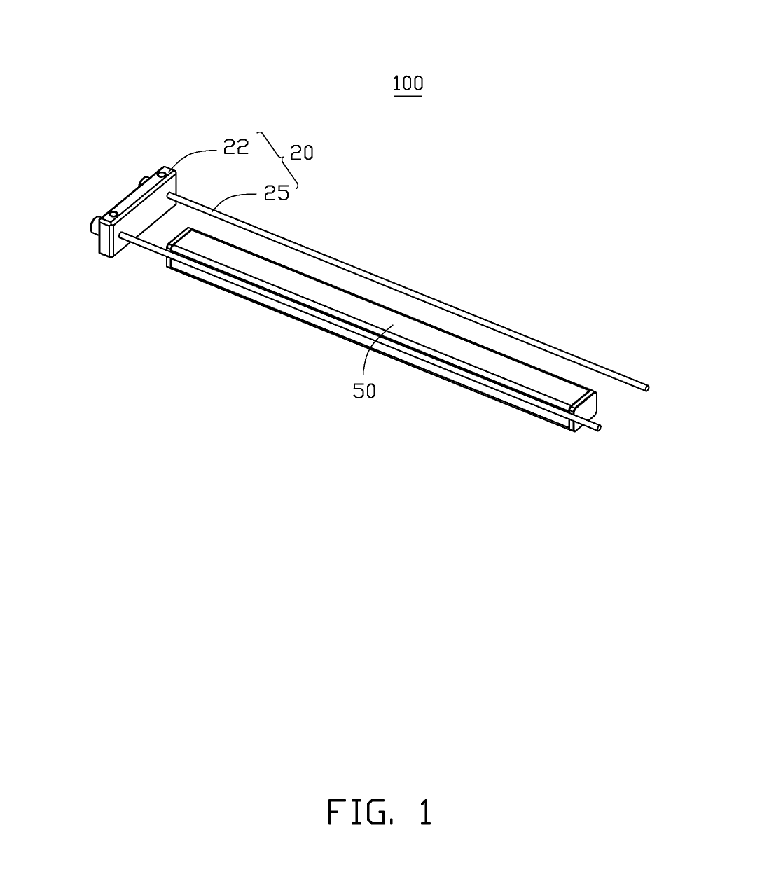

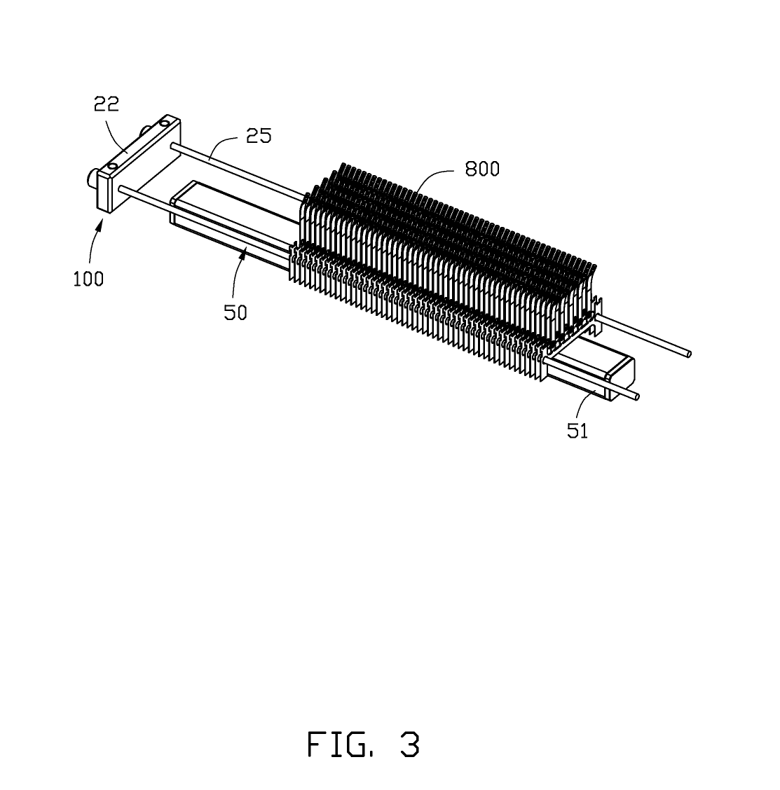

FIG. 1 shows a separating apparatus 100 including a support assembly 20 and a magnet assembly 50 positioned adjacent to the support assembly 20. The separating apparatus 100 can be used for separating a plurality of stacked magnetically conductible workpieces 800 (as shown in FIG. 3). In the illustrated embodiment, the magnetically conductible workpieces 800 are button fragments. In other embodiments, the magnetically conductible workpieces 800 can be antenna fragments or other type stacked magnetically conductible slices.

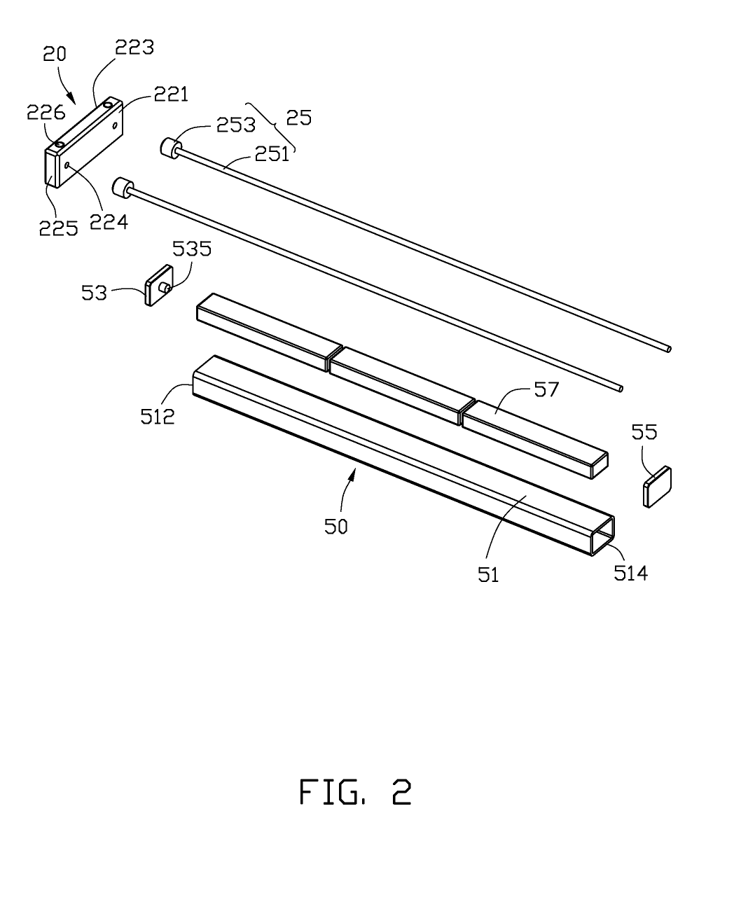

The support assembly 20 can include a support member 22 and two parallel support rods 25 fixedly positioned on the support member 22. FIG. 2 shows that the support member 22 can be substantially cubic. The support member 22 can include a first surface 221, a second surface 223 located opposite to the first surface 221, and four side surfaces 225 coupled the first surface 221 and the second surface 223. Two spaced fixing holes 224 can be defined in the first surface 221. Two locking holes 226 can be separately defined in one side surface 225 along a direction, which can be parallel to the first surface 221. Each locking hole 226 can communicate with the corresponding fixing hole 224. The magnetically conductible workpieces 800 can be made of ferromagnetic materials, or other magnetically conductible materials, such as amorphous alloy.

The support rods 25 can be made of stainless steel. Each support rod 25 can include a main body 251 and a fixing portion 253 coupling with the main body 251. The main body 251 can be substantially cylindrical shaped. A diameter of the fixing portion 253 can be greater than a diameter of the main body 251 and a diameter of a hole of the fixing hole 224. The main body 251 can be received through the corresponding fixing hole 224. The fixing portion 253 can resist against the second surface 223 of the support member 22. A fastener (not shown), such as a screw, can be inserted in the locking hole 226 to lock the main body 251 in the fixing hole 224. In an alternative embodiment, a number of the support rods 25 can be one, three or more.

The magnet assembly 50 can be spaced a predetermined distance from the support rods 25. The magnet assembly 50 can include a holding member 51, a first cover 53, a second cover 55, and a plurality of magnet members 57. The plurality of magnet members 57 can be arranged in order and received in the holding member 51. The first cover 53 and the second cover 55 can cover opposite ends of the holding member 51.

The holding member 51, which can be a substantially rectangular sleeve, can be made of stainless steel. The holding member 51 can extend along a direction parallel to an extending direction of the support rod 25 and can define a first opening 512 at one end and a second opening 514 at another end. In other embodiments, the holding member 51 can be made of other non-ferromagnetic material, such as plastic. The first cover 53 can be coupled to the holding member 51 and can cover the first opening 512. In the illustrated embodiment, the first cover 53 can be welded to cover the first opening. A first protrusion 535 can be formed on the first cover 53 and can extend towards the holding member 51. The second cover 55 can be coupled to the holding member 51 and can cover the first opening 514 in a similar fashion as the first cover 53. A second protrusion can be formed on the first cover 53 and can extend towards the holding member 51.

The plurality of magnet members 57 can be received in a substantially straight line in the holding member 51. Adjacent end portions of two neighboring magnet members 57 can have the same polarity. Directions of inner magnetic fields of the plurality of magnet members 57 can be substantially parallel to an extending direction of the support rods 25. The first protrusion 535 can resist the magnet member 57 adjacent to the first cover 53. The second protrusion can resist the magnet member 57 adjacent to the second cover 55. Thus, the plurality of magnet members 57 can be received in the holding member 51 without movement. In the illustrated embodiment, three magnet members 57 can be arranged in the holding member 51, and the magnet members 57 are permanent bar magnets. In other embodiments, the magnet members 57 can be electromagnet, a number of the magnet members 57 are not limited to three, there may be one, or two, or more.

Referring to FIGS. 1 to 3, the plurality of magnetically conductible workpieces 800 can be movably sleeved on the two support rods 25. The separating apparatus 100 with the magnetically conductible workpieces 800 can be inserted into a purge tank. Distances can be adjusted between the support assembly 20 and the magnet assembly 50. In the illustrated embodiment, a distance range between the support rod 25 and the holding members 51 is about from 0.1 mm to 10 mm. Each of the magnetically conductible workpieces 800 can be forced to slide along the support rods 25 towards the corresponding adjacent end of the support rod 25 by magnetic field, and can be spaced from neighboring magnetically conductible workpieces 800. Therefore, the surfaces of the ferromagnetic workpiece 800 can be washed cleanly.

In other embodiments, the first cover 53 and the second cover 55 can be omitted. The plurality of magnet members 57 can be directly assembled with the holding member 51. The holding member 51 can be omitted when the number of the magnet members 57 is one, and then the magnet member 57 can be positioned adjacent to the support rods 25 with preset distances.

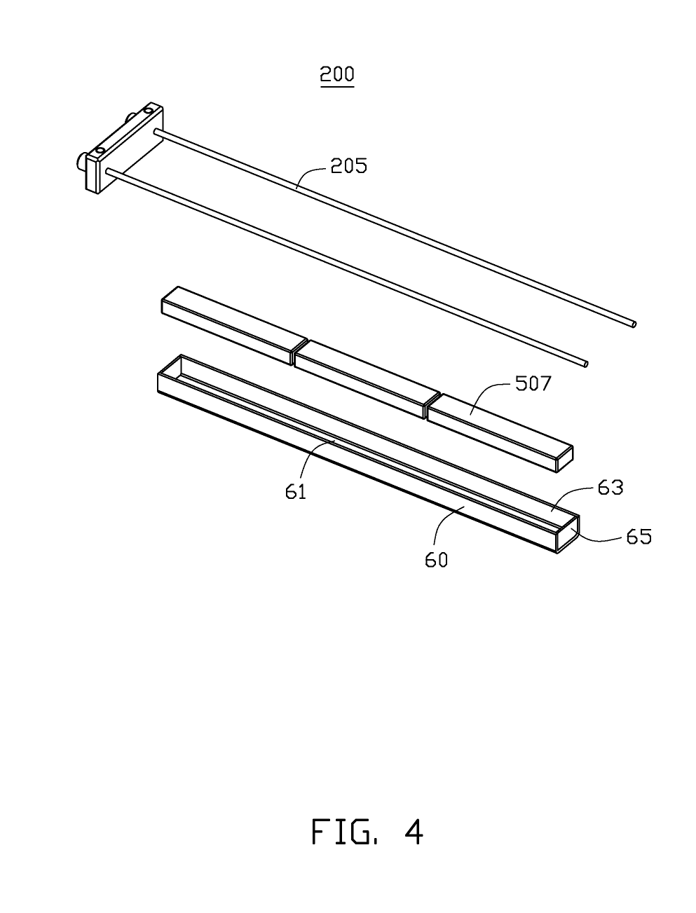

FIG. 4 shows another separating apparatus 200 of a second embodiment similar to the separating apparatus 100 of the first embodiment. A difference of the another separating apparatus 200 is that a holding member 60 of the another separating apparatus 200 can define a longitudinal opening 601. A cross section of the holding member 60 can be U-shaped. An extension direction of the holding member 51 can be parallel to the extension direction of the support rods 205. The holding member 60 can include a bottom board 61, two side boards 63 substantially perpendicularly extending from opposite ends of the bottom board 63, and two side walls 65 substantially perpendicularly extending from other two edges of the bottom board 61. The two side boards 63 and the two side walls 65 together can define the opening 601. Another plurality of magnet members 507 can be arranged in the holding member 60 via the opening 601. Two ends of the plurality of magnet members 507 can resist against the side wall 65, to stop the plurality of magnet members 507 received in the holding member 60 from moving.

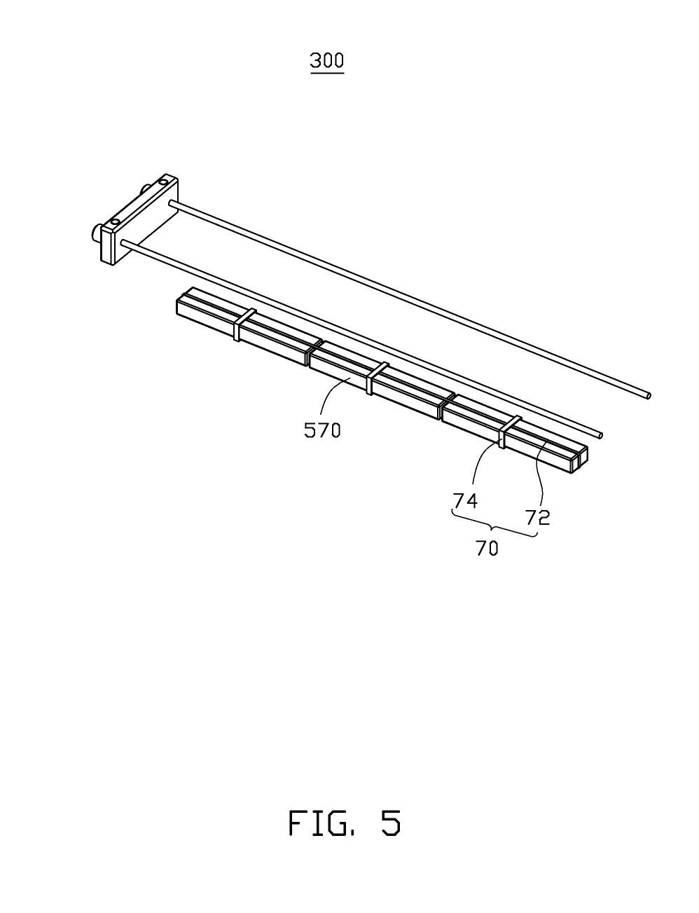

FIG. 5 shows a yet another separating apparatus 300 of a third embodiment similar to the separating apparatus 100 of the first embodiment. A difference of the yet another separating apparatus 300 is that a holding member 70 of the yet another separating apparatus 300 can include a first frame 72 and a plurality of second frames 74 coupled with the first frame 72. The first frame 72 can be substantially rectangular shaped and can sleeve around yet another plurality of magnet members 570. A total length of the plurality of the yet another magnet members 570 can be equal to the first frame 72. Two ends of the yet another plurality of magnet members 570 can resist the two end inner surfaces of the first frame 72 to stop the yet another plurality of magnet members 570 received in the holding member 70 from moving. The separate second frames 74 can be sleeved on the first frame 72 to enable the first frame 72 to resist against the corresponding yet another magnet member 570.

As described above, the separating apparatus can be capable of separating the magnetically conductible workpieces 800 independently via forces produced by the plurality of magnet member. Thus, surfaces of the ferromagnetic workpiece 800 can be cleaned.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A separating apparatus comprising:
a support assembly comprising a support member and a support rod fixedly coupled with the support member, the support configured to be capable of supporting stacked magnetically conductible workpieces;
a magnet assembly positioned adjacent to the support assembly, the magnet assembly comprising a holding member and at least one magnet member received in the holding member, wherein a direction of an inner magnetic field of the at least one magnet member is parallel to an extending direction of the support rod, the at least one holding member is spaced from the support rod with a predetermined distance to separate the stacked magnetically conductible workpieces independently along the support rod via the inner magnetic field of the at least one magnet member.

2. The separating apparatus of claim 1, wherein the at least one magnet member is arranged in a straight line, and adjacent end portions of two neighbored magnet members of the at least one magnet member have a same polarity.

3. The separating apparatus of claim 1, wherein the holding member is a substantially rectangular sleeve, the holding member extends in a direction parallel to an extending direction of the support rod, and the at least one magnet member is a bar magnet and is received in the holding member along a longitudinal direction of the holding member.

4. The separating apparatus of claim 1, wherein the holding member forms a first opening at one end and a second opening at another end, the magnet assembly further comprises a first cover and a second cover, the first cover configured to cover the first opening, and the second cover configured to cover the second opening.

5. The separating apparatus of claim 1, wherein the support member further comprises a first surface, a second surface located opposite to the first surface, and four side surfaces coupling the first surface and the second surface, a fixing holes is defined in the first surface, the support rod is fixedly received through the fixing hole.

6. The separating apparatus of claim 5, wherein the support rod further comprises a main body and a fixing portion coupling with the main body, the main body is received through the fixing hole, a diameter of the fixing portion is greater than a diameter of the main body and a diameter of a hole diameter of the fixing hole, and the fixing portion resists against the second surface.

7. The separating apparatus of claim 5, wherein a locking hole is defined in one of the four side surfaces and communicates with the fixing hole.

8. The separating apparatus of claim 1, wherein a distance range is about from 0.1 mm to 10 mm between the support rod and the holding member.

9. The separating apparatus of claim 1, wherein the holding member further comprises: a bottom board; two side boards extending substantially perpendicular from opposite ends of the bottom board, and two side walls extending substantially perpendicular from other two edges of the bottom board, the two side boards and the two side walls together define an opening, the at least one magnet member is received in the holding member via the opening.

10. The separating apparatus of claim 1, wherein the holding member further comprises a first frame and at least one of second frame, the first frame sleeves around at least one magnet member, the at least one of second frame separately sleeves the first frame to enable the first magnet resist against the at least one magnet member.

11. A separating apparatus comprising:
a support assembly comprising a support member and a support rod fixedly coupled with the support member, the support configured for supporting tacked magnetically conductible workpieces;
a magnet member positioned adjacent to the support assembly, wherein a direction of an inner magnetic field of the magnet member is parallel to an extending direction of the support rod, the magnet member is spaced from the support rod by a predetermined distance thereby separating the stacked magnetically conductible workpieces independently along the support rod via the inner magnetic field of the at least one magnet member.

12. The separating apparatus of claim 11, wherein the support member further comprises a first surface, a second surface located oppositely to the first surface, and four side surfaces coupling the first surface and the second surface, a fixing holes is defined in the first surface, the support rod is fixedly received through the fixing hole.

13. The separating apparatus of claim 12, wherein the support rod further comprises a main body and a fixing portion coupling with the main body, the main body is received through the fixing hole, a diameter of the fixing portion is greater than a diameter of the main body and a hole diameter of the fixing hole, and the fixing portion resists against the second surface.

14. The separating apparatus of claim 12, wherein a locking hole is defined in one of the four side surfaces and communicates with the fixing hole.

15. The separating apparatus of claim 11, wherein the magnet member is a bar permanent magnet.
